(19) United States
(12) Patent Application Publication
(10) Pub. No.: US 2024/0418559 A1
(43) Pub. Date: Dec. 19, 2024

(54) STATE MONITORING FOR A VIBRONIC SENSOR

(71) Applicant: Endress+Hauser SE+Co. KG, Maulburg (DE)

(72) Inventor: Sascha D'Angelico, Rümmingen (DE)

(21) Appl. No.: 18/704,234

(22) PCT Filed: Sep. 27, 2022
(86) PCT No.: PCT/EP2022/076765

§ 371 Date: Apr. 24, 2024

(30) Foreign Application Priority Data
Nov. 11, 2021 (DE) 10 2021 129 416.9

(51) Int. Cl. G01F 23/296

(52) U.S. Cl. CPC G01F 23/2966

(57) ABSTRACT

A computer-implemented method for monitoring the state of a vibronic sensor comprising a mechanically vibratable unit and a drive/reception unit that is designed to excite the mechanically vibratable unit to vibrate mechanically, and to receive the mechanical vibrations of the mechanically vibratable unit and to convert them into a reception signal includes the following method steps: recording a spectrum of the vibronic sensor as input data, providing the input data to a neural network designed to determine a statement about the state of the vibronic sensor on the basis of the input data, and outputting the statement about the state of the vibronic sensor.

The present invention relates to a method, in particular a computer-implemented method, for monitoring the state of a vibronic sensor comprising a mechanically vibratable unit and a drive/reception unit that is designed, by way of an excitation signal, to excite the mechanically vibratable unit to vibrate mechanically, and to receive the mechanical vibrations of the mechanically vibratable unit and to convert them into a reception signal. The invention furthermore relates to a computer program for carrying out the method according to the invention, and to a computer program product on which the computer program is stored.

Vibronic sensors are often used in process and/or automation engineering. In the case of fill level measuring devices, they have at least one mechanically vibratable unit such as, for example, a vibrating fork, a single rod, or a diaphragm. During operation, mechanical vibrations are excited in the latter by a drive/receiving unit, often in the form of an electromechanical transducer unit that can, in turn, be a piezoelectric drive or an electromagnetic drive, for example. In the case of flow meters, the mechanically vibratable unit can, however, also be designed as a vibratable tube, through which the respective medium flows, such as in a measuring device operating according to the Coriolis principle.

A wide variety of corresponding field devices are made by the applicant and, in the case of fill level measuring devices, are distributed under the name LIQUIPHANT or SOLIPHANT, for example. The underlying measurement principles are known in principle from numerous publications. The drive/reception unit excites the mechanically vibratable unit to vibrate mechanically by means of an electrical excitation signal. Conversely, the drive/reception unit can receive the mechanical vibrations of the mechanically vibratable unit and convert them into an electrical reception signal. Accordingly, the drive/reception unit is either a separate drive unit and a separate reception unit, or a combined drive/reception unit.

In many instances, the drive/reception unit is part of an electrical resonant feedback circuit by means of which the excitation of the mechanically vibratable unit to produce mechanical vibrations takes place. For example, the resonant circuit condition according to which the amplification factor is ≥1 and all phases occurring in the resonant circuit result in a multiple of 360° must be fulfilled for a resonant vibration. For this reason, a predeterminable value for the phase shift, i.e. a setpoint for the phase shift between the excitation signal and the reception signal, is often set. A wide variety of solutions are available for this in the prior art, such as those disclosed in DE102006034105A1, DE102007013557A1, DE102005015547A1, DE102009026685A1, DE102009028022A1, DE102010030982A1 or DE00102010030982A1. Other possible excitation methods are described, for example, in DE102012102589A1 or DE102016111134A1.

Both the excitation signal and the reception signal are characterized by their frequency ω, amplitude A, and/or phase ϕ. Accordingly, changes in these variables are usually used to determine the process variable in question, such as a predetermined fill-level of a medium in a tank, or else the density and/or viscosity of a medium, or the flow of a medium through a pipe. In the case of a vibronic level switch for liquids, for example, a distinction is made between whether the vibratable unit is covered by the liquid or vibrates freely. The two states, the free state and the covered state, are thus differentiated—for example, based on different resonant frequencies, i.e., a frequency shift. The density and/or viscosity, in turn, can only be determined with such a measuring device if the vibratable unit is covered by the medium.

As described, for example, in DE10050299A1, the viscosity of a medium can be determined by means of a vibronic sensor on the basis of the frequency-phase curve (ϕ=g(ω)). This procedure is based on the dependence of the damping of the vibratable unit on the viscosity of the respective medium. It should be noted that the lower the viscosity, the steeper the drop in the frequency-phase curve. In order to eliminate the influence of density on the measurement, the viscosity is determined using a frequency change caused by two different values for the phase, i.e. by means of a relative measurement. For this purpose, either two different phase values can be set and the associated frequency change can be determined, or a predefined frequency band is passed through and the times when at least two predefined phase values are reached is determined.

From DE102007043811A1 it has also become known that a change in the natural frequency and/or resonant frequency and/or phase position can be used to infer a change in viscosity, and/or to determine the viscosity on the basis of stored dependencies of the vibrations of the vibratable unit on the viscosity of the respective medium. The dependence of the determination of the viscosity on the density of the medium must also be taken into account in this procedure.

For determining and/or monitoring the density of a medium, a method and a device have become known from DE10057974A1, by means of which the influence of at least one disturbance variable, for example the viscosity, on the vibration frequency of the mechanically vibratable unit can be determined and compensated accordingly. DE102006033819A1 further describes setting a predeterminable phase shift between the excitation signal and the reception signal, in which effects of changes in the viscosity of the medium on the mechanical vibrations of the mechanically vibratable unit are negligible. The density is substantially determined according to the formula

$${ρ}_{Med} = \frac{1}{K} [ {( \frac{{f}_{0 , Vak} + C \cdot t + A \cdot {t}^{2}}{{f}_{T , P , Med}} )}^{2} \cdot ( 1 + D \cdot p ) - 1 ]$$

where K is the density sensitivity of the mechanically vibratable unit, F_{0,vak} is the frequency of the mechanical vibrations in the vacuum, C and A are the linear or respectively quadratic temperature coefficients of the mechanically vibratable unit, t is the process temperature, F_{T,P,,med} is the frequency of the mechanical vibrations in the medium, D is the pressure coefficient, and p is the pressure of the medium.

In order to be independent of empirical assumptions, an analytical measuring principle for determining the density and/or viscosity by means of a vibronic sensor has become known from DE102015102834A1, which takes into account interactions between the vibratable unit and the medium using a mathematical model. The sensor is operated at two different predeterminable phase shifts and the process variables of density and/or viscosity are determined from the respective response signal.

Irrespective of which process variable is determined and/or monitored by means of a vibronic sensor, various interfering influences can negatively affect the measurement accuracy of the respective sensor. So-called external vibrations, which can be caused, for example, by pumps and/or ultrasonic baths at the location where the sensor is used, are particularly problematic. In this regard, a vibronic sensor has become known from the published patent application DE102012101667A1, in which a control/evaluation unit is configured to control the vibration excitation in the presence of at least one external vibration as a function of the frequency and/or the amplitude of the external vibration in such a way that the reception signal is substantially undisturbed by the external vibration, and/or to suppress at least one frequency of external vibration in the reception signal. In principle, however, this requires knowledge of the external vibrations occurring in each case. From DE102016124740A1, in turn, a method is known in which, in a first operating mode, an excitation of the vibronic sensor to perform mechanical vibrations is carried out, and, in a second operating mode, the reception signal is received without vibration excitation. An external interfering influence for the vibronic sensor can be determined based on the frequency of the reception signal in the second operating mode. Here too, however, it can be difficult to differentiate between the various interfering influences and to carry out a comprehensive elimination of the interfering influences on the actual measurement. However, from DE102015121621B4 a sensor diagnosis based on a spectrum of the sensor has become known. However, in order to determine a statement about the state of the sensor, special and specific criteria must be established, so that it is generally not possible to diagnose the sensor independently of the influences of various environmental parameters. Overall, in many applications, the evaluation of spectra is arbitrarily complex.

Therefore, the present invention is based on the object of providing the most comprehensive and reliable state monitoring possible for a vibronic sensor.

This object is achieved by the method according to claim 1, by the device according to claim 12, by the computer program according to claim 13, and by the computer program product according to claim 14.

The method according to the invention is a method, in particular a computer-implemented method for monitoring the state of a vibronic sensor comprising a mechanically vibratable unit and a drive/reception unit that is designed, by way of an excitation signal, to excite the mechanically vibratable unit to vibrate mechanically, and to receive the mechanical vibrations of the mechanically vibratable unit and to convert them into a reception signal, comprising the following method steps:
recording at least one spectrum of the vibronic sensor as input data,
providing the input data to a neural network that is designed to determine a statement about the state of the vibronic sensor at least on the basis of the input data, and
outputting the statement about the state of the vibronic sensor.

While a wide variety of methods have become known from the prior art, by means of which diagnoses of sensors, in particular also vibronic sensors, are possible, an accurate condition monitoring of the sensor unit and/or drive/reception unit is only possible to a very limited extent and is sometimes very complex. A spectrum of the vibronic sensor in principle contains all information about the mechanical vibrations, the interaction with various environmental conditions, the electromechanical conversion by means of the drive/reception unit, or also external influences on the sensor and various sensor parameters. However, the evaluation of the spectra is typically arbitrarily complex.

The interpretation of spectra of the vibronic sensor can be considerably improved and simplified by means of the neural network for monitoring the state of the vibronic sensor. For example, the measured spectra contain a wide variety of external and internal interfering influences which can hardly be distinguished from the actual measurement information by conventional means. By contrast, complex patterns in the measured spectra can also be reliably detected by means of the method according to the invention.

An advantage of the method according to the invention can also be considered to be that comprehensive state monitoring of the sensor becomes possible without the sensor having to be removed from the respective process for which it is used.

Preferably, the neural network comprises two or more output neurons, the number of output neurons being a measure of the number of different categories or the classifications that can be made.

For example, an already trained neural network can be used, which has preferably been trained in a supervised or semi-supervised learning process. Interfering influences on the measurement by means of the vibronic sensor therefore do not have to be known a priori, but rather can be determined using the method according to the invention, in particular also during continuous operation of the sensor.

In addition, it is possible that a state monitoring or diagnosis of the sensor can be carried out on the basis of the statement about the state of the sensor, or that the influence of at least one determined interference of the regular measurement operation is suitably compensated, in particular compensated by calculation. For example, the method can be used to analyze the vibration behavior of the sensor.

The method according to the invention can be carried out at predeterminable points in time or singularly on demand. A periodic implementation of the method at predeterminable time intervals is also conceivable. Thus, the sensor diagnosis according to the invention can be carried out as a recurring test or as continuous monitoring in addition to the normal measuring process.

In one embodiment of the method, the at least one spectrum is a frequency spectrum, in particular an amplitude or phase, of the reception signal, for example as a function of an excitation frequency of the excitation signal.

Preferably, the at least one statement about the state of the vibronic sensor is a statement about the operability of the sensor. However, detailed state monitoring of the sensor can also be carried out with regard to various influencing variables for the measured spectrum. In particular, a distinction can be made between regular and irregular influencing variables. Regular influencing variables are those influences which originate from the environmental conditions and the respective specific process in which the sensor is used. Irregular or error-related influences on the state of the sensor, such as defects on the sensor or application-related changes, in particular build-up or corrosion in the region of the sensor unit can, in contrast, lead to functional impairment or even failure of the respective sensor.

Thus, in one embodiment, the statement about the state of the vibronic sensor is, for example, a statement about the state of the sensor unit, in particular a built-up or corrosion in the region of the sensor unit, a degree of coverage, a damping, a measuring sensitivity of the vibratable unit, or mechanical damage to the vibratable unit, for example a bending of at least one vibrating element. The statement about the state of the vibronic sensor can, however, also be a statement about at least one environmental parameter or a change in at least one environmental parameter, such as a density, viscosity, temperature or a pressure of the medium, or a statement about the drive/reception unit, in particular in relation to a piezoelectric element, for example a break in the piezoelectric element, and/or an adhesive point, a statement about vibrations, in particular external vibrations, in an environment of the sensor, or a statement about electrical contacting in the region of the sensor, such as a cable break, short circuit, or an electrical defect.

In the event that the network is designed to diagnose the sensor with regard to various variables influencing the spectrum, and in which the neural network comprises more than two output neurons, various influencing variables that are related to one another can also be grouped appropriately in order to keep the number of necessary output neurons as small as possible.

In a further embodiment of the method according to the invention, the neural network is a deep neural network. The network thus comprises at least two layers, with the number of layers and/or the number of neurons per layer preferably correlating with the complexity of the spectrum, in particular with the complexity of the pattern to be recognized, and the number of influencing variables affecting the spectrum.

In one embodiment, the input data are supplied to a data preprocessing module, which data preprocessing module comprises at least one filter for filtering the input data with regard to at least one piece of information, and wherein the filtered input data is at least partially provided to the neural network. In principle, the data preprocessing module is used for information compression, for example to reduce a number of input neurons of the neural network required for monitoring the state of the vibronic sensor.

On the one hand, it is conceivable that the filter is a conventional filter function. However, it is also advantageous if the data preprocessing module comprises a neural network for data preprocessing, in particular a convolutional neural network (CNN). This neural network for data preprocessing of the data preprocessing module can also be part of the neural network for state monitoring of the vibronic sensor, in particular it can be connected upstream of the network monitoring the state of the vibronic sensor.

With respect to the data preprocessing module, it is further advantageous if the data preprocessing module is designed to determine at least one resonance peak, in particular a peak height, a peak quality, or a frequency, a number of resonance peaks within a spectrum, a phase slope in the spectrum, a phase jump in the spectrum, or a background signal of the spectrum. In this way, individual peaks with special properties can be filtered out. Such variables or information determined by means of the data preprocessing module can also be additionally provided to the neural network for monitoring the state of the sensor.

In principle, however, other characteristic variables or characteristics associated with the spectrum can also be determined for the respective spectrum. Here, the suitable variables differ depending on the spectrum used, e.g. depending on whether an amplitude or phase spectrum is used.

In one embodiment of the method, the network is designed to carry out predictive maintenance of the vibronic sensor, at least on the basis of the input data.

In this context, it is advantageous if the neural network is a recurrent neural network. In such an embodiment of the network for monitoring the state of the vibronic sensor, a feedback can take place which is used to determine a state of the sensor in the past or for comparison with a state of the sensor from the past. This embodiment thus provides a memory function.

It is also advantageous if at least one piece of information from the spectrum and/or a statement about the state of the sensor is/are recorded as a function of the time. However, information that is determined by means of the data preprocessing module can also be recorded. This allows an approximation of possible changes in the future to be carried out. In addition, it is possible to generate a statement about how long the sensor will remain functional under substantially constant conditions or constant rates of change for certain influencing variables.

A further embodiment of the method according to the invention includes that the neural network is designed to determine, at least on the basis of the input data, an in particular predeterminable fill level of a medium in a container. In addition to state monitoring, the fill level of the medium in a container, for example a pipeline or a tank, can additionally be determined in a conventional manner by means of the method according to the invention.

The object underlying the invention is further achieved by a data processing device comprising means for performing a method according to the invention in accordance with at least one of the embodiments described. For example, the device can be an electronic system of the sensor, or a separate computing unit, such as a computer. The method according to the invention can thus on the one hand be executed externally on a computing unit, for example on a computer. Alternatively, the method can also be implemented directly in the sensor, for example in an electronic unit of the sensor.

The object underlying the invention is further achieved by a computer program for monitoring the state of a vibronic sensor comprising computer-readable program code elements which, when executed on a computer, cause the computer to execute a method according to the invention in accordance with at least one of the embodiments described.

Finally, the object underlying the invention is achieved by a computer program product comprising a computer program according to the invention and at least one computer-readable medium on which at least the computer program is stored.

The vibronic sensor is excited, for example, to mechanical vibrations at a resonant frequency. In addition to the fill level of a medium, the vibronic sensor can also be used to determine other process variables of the medium, such as the density of the medium and/or the viscosity of the medium.

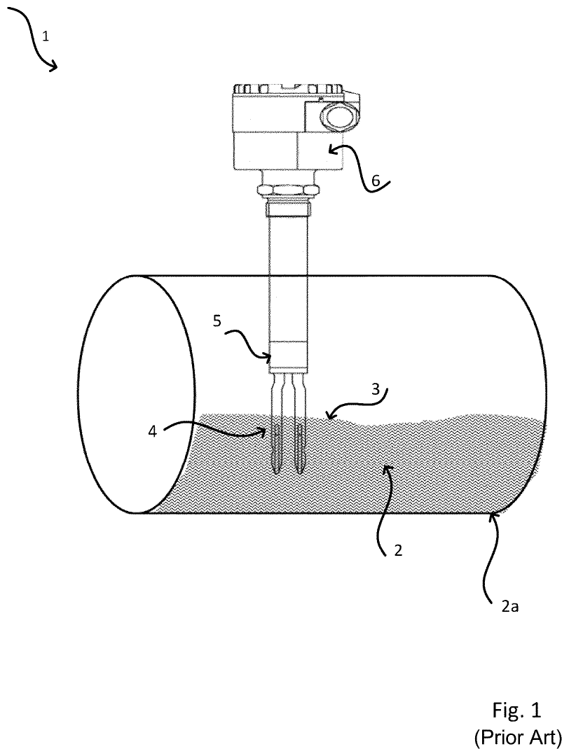

The invention and advantageous embodiments are described in more detail below with reference to the figures FIG. 1-FIG. 6. In the figures:

FIG. 1: is a schematic drawing of a vibronic sensor according to the prior art,

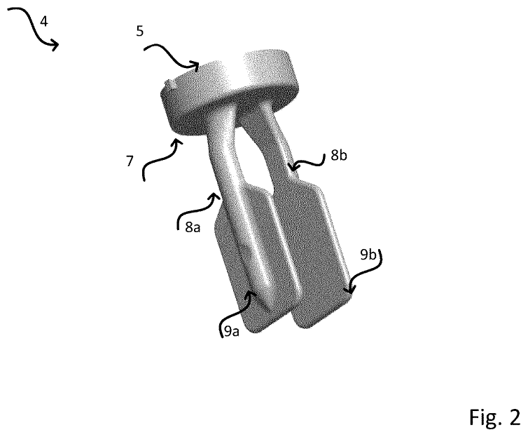

FIG. 2: is a schematic drawing of a vibratable unit in the form of a vibrating fork,

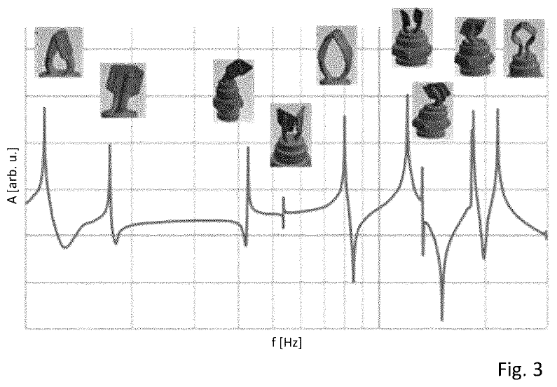

FIG. 3 shows an amplitude spectrum of a vibronic sensor as a function of the excitation frequency and the various vibration modes of the vibratable unit in the form of a vibrating fork,

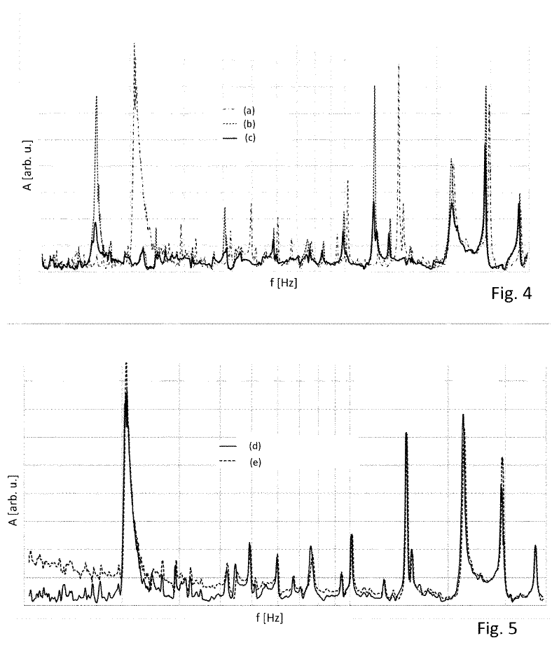

FIG. 4 shows exemplary amplitude spectra of a functional vibronic sensor in different media,

FIG. 5 shows exemplary amplitude spectra of a functional and damaged vibronic sensor, partly also in different media, and

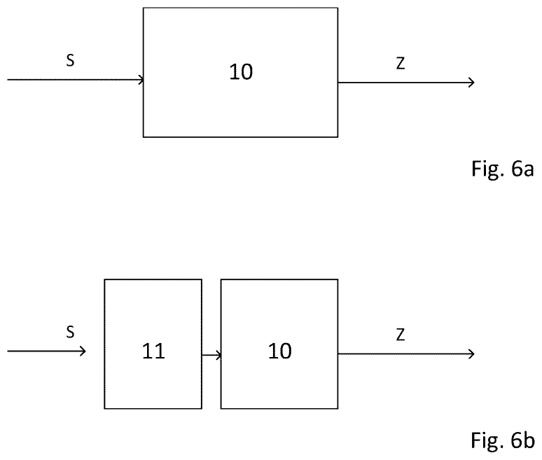

FIG. 6 illustrates the method according to the invention.

The same elements are provided with the same reference signs in the figures.

FIG. 1 shows a vibronic sensor 1 having a sensor unit 3 comprising a vibratable unit 4 in the form of a vibrating fork, which is partially immersed in a medium 2, which is located in a tank 2a. The mechanically vibratable unit is excited to mechanical vibrations by means of the drive/reception unit 5 and can be, for example, a piezoelectric stack drive or bimorph drive. However, it is understood that other embodiments of a vibronic sensor are also covered by the invention. Furthermore, an electronic unit 6 by means of which the signal detection, signal evaluation and/or signal supply takes place is shown.

FIG. 2 shows a side view of a vibratable unit 4 in the form of a vibrating fork, such as that integrated in the vibronic sensor 1 marketed by the applicant under the name LIQUIPHANT. The vibrating fork 4 comprises two vibrating rods 8a,8b which are integrally formed on a diaphragm 7 and on the end of each of which a paddle 9a,9b is integrally formed. The vibrating rods 8a,8b together with the paddles 9a,9b are frequently also referred to as fork prongs. In order to cause the mechanically vibratable unit 4 to vibrate mechanically, a force is applied to the diaphragm 7 by means of a drive/reception unit 5 which is firmly bonded to the side of the diaphragm 7 facing away from the vibrating rods 8a,8b. The drive/reception unit 5 is an electromechanical transducer unit, and comprises, for example, a piezoelectric element, or also an electromagnetic drive [not shown]. Either the drive unit 5 and the reception unit are designed as two separate units, or as a combined drive/reception unit. In the case that the drive/reception unit 5 comprises a piezoelectric element, the force applied to the diaphragm 7 is generated by applying an excitation signal U_{A}, for example in the form of an electrical AC voltage. A change in the applied electrical voltage causes a change in the geometric shape of the drive/reception unit 5, i.e. a contraction or a relaxation within the piezoelectric element such that the application of an electrical AC voltage as excitation signal U_{A} causes a vibration of the diaphragm 7 that is firmly bonded to the drive/reception unit 5. Conversely, the mechanical vibrations of the vibratable unit are transmitted via the diaphragm to the drive/reception unit 5 and converted into an electrical reception signal Uₑ. In this case, the frequency of the reception signal Uₑ corresponds to the mechanical vibration frequency f of the vibratable unit 4.

FIG. 3 shows, by way of example, an amplitude spectrum A(f) of a vibronic sensor 1 as a function of the excitation frequency f together with the various vibration modes of the vibratable unit 4 in the different vibration modes. Each individual vibration mode is characterized by a specific resonant frequency, a phase and a specific value for an internal damping of the vibratable unit 4, and shows a different reaction to different external influencing variables such as a covering or fluctuations in temperature, density or viscosity. In addition, it is typically not possible to assign an influencing variable to a specific vibration mode. There are also differences due to unavoidable production-related tolerances with regard to various sensors 1.

It is often not possible to differentiate between regular influencing variables, some of which are unknown, and irregular influencing variables, such as build-up, corrosion or mechanical or electrical defects in the region of the sensor unit or drive/reception unit. To illustrate these problems, three amplitude spectra of a functional sensor 1 in three different media, air (a), water (b) and a viscous liquid (c), are shown in FIG. 4. The spectra differ significantly from one another. This complexity with respect to the evaluation of spectra becomes even clearer when compared with the spectra of a functional (d) and a non-functional (e) sensor 1 shown in FIG. 5, both in air.

It should be noted that the same or similar complications exist in the case that the spectrum is a phase spectrum, and that the considerations made here can also be used mutatis mutandis for other spectra of a vibronic sensor.

By means of the present invention, comprehensive state monitoring can be carried out using a neural network 10, as illustrated in FIG. 6. In this way, the complex patterns and relationships in different spectra can be detected and evaluated. In the embodiment shown in FIG. 6a, at least one spectrum S of the sensor 1 is provided as input data to a neural network for monitoring the state of the sensor 1. The network 10 determines a statement Z about the state of the sensor 1 and outputs this statement Z. Even if only one statement Z was illustrated here as the output of the neural network 10, two or more output neurons can also be provided for different classifications of the state of the sensor.

In the embodiment of the method according to the invention shown in FIG. 6b, a data preprocessing module 11 is also provided which, by way of example, can comprise a classic filter function or also a neural network for data preprocessing. The data preprocessing module 11 is connected upstream of the neural network 10 and is used to filter the input data, i.e. the spectra S with regard to at least one piece of information, in particular about the spectrum S or the sensor 1. For example, the information is a resonance peak, in particular a peak height, a peak quality, or a frequency, a number of resonance peaks within a spectrum S, or a background signal of the spectrum S.

### LIST OF REFERENCE SIGNS

1 Vibronic sensor
2 Medium
2a Tank
3 Sensor unit
4 Vibratable unit
5 Drive/reception unit
6 Electronic unit
7 Diaphragm
8a,8b Vibrating rods
9a,9b Paddles
10 Neural network
11 Data preprocessing module
U_{A} Excitation signal
U_{E} Reception signal
F Frequency
Δϕ Predeterminable phase shift
A Amplitude
S Spectrum
Z Statement about the state of the sensor

1-14. (canceled)

15. A computer-implemented method for monitoring a state of a vibronic sensor, comprising:
providing the vibronic sensor, including:
a mechanically vibratable unit; and
a drive/reception unit designed to excite, via an excitation signal, the mechanically vibratable unit to vibrate mechanically and to receive mechanical vibrations of the mechanically vibratable unit and to convert the mechanical vibrations into a reception signal;
recording at least one spectrum of the vibronic sensor as input data,
providing the input data to a neural network that is designed to determine a statement about the state of the vibronic sensor on the basis of the input data; and
outputting the statement about the state of the vibronic sensor.

16. The method according to claim 15,
wherein the at least one spectrum is a frequency spectrum.

17. The method according to claim 16,
wherein the frequency spectrum includes an amplitude or a phase of the reception signal as a function of a frequency of the excitation signal.

18. The method according to claim 15,
wherein the statement about the state of the vibronic sensor is a statement about the state of the sensor unit (3), including a build-up or corrosion in a region of the sensor unit, a degree of coverage, a damping, or a sensitivity of the vibratable unit, a statement about at least one environmental parameter or a change of the at least one environmental parameter, a statement about the drive/reception unit, a statement about vibrations in an environment of the sensor, or a statement about an electrical contact in the region of the sensor.

19. The method according to claim 15,
wherein the neural network is a deep neural network.

20. The method according to claim 15, further comprising:
supplying the input data to a data preprocessing module having at least one filter for filtering the input data with respect to at least one piece of information; and
providing the filtered input data to the neural network.

21. The method according to claim 20,
wherein the data preprocessing module includes a neural network for data preprocessing.

22. The method according to claim 21,
wherein the data preprocessing module is designed to determine at least one resonance peak, a number of resonance peaks within a spectrum, or a background signal of the spectrum.

23. The method according to claim 15,
wherein the neural network is designed to carry out predictive maintenance of the vibronic sensor at least on the basis of the input data.

24. The method according to claim 23,
wherein the neural network is a recurrent neural network.

25. The method according to claim 24, further comprising:
recording as a function of time at least one piece of information from the spectrum and/or the statement about the state of the sensor.

26. The method according to at claim 15,
wherein the neural network is designed to determine on the basis of the input data a predeterminable fill level of a medium in a container.

27. A data processing device comprising an electronic system of a vibronic sensor or a separate computing unit, wherein the data process device is embodied to:
record at least one spectrum of the vibronic sensor as input data,
provide the input data to a neural network that is designed to determine a statement about a state of the vibronic sensor on the basis of the input data, and
output the statement about the state of the vibronic sensor.
